(19) United States
(12) Patent Application Publication
(10) Pub. No.: US 2026/0304095 A1
(43) Pub. Date: Oct. 1, 2026

(54) METHODS FOR ACCESS NETWORK EXPOSURE ON CORE NETWORK SERVICE BUS

(71) Applicant: InterDigital Patent Holdings, Inc., Wilmington, DE (US)

(72) Inventors: Michel Roy, Candiac (CA); Ulises Olvera-Hernandez, Saint-Lazare (CA); Samir Ferdi, Kirkland (CA); Saad Ahmad, Montreal (CA); Catalina Mladin, Hatboro, PA (US); Sebastian Robitzsch, London (GB); Michael Starsinic, Newtown, PA (US); Kevin Di Lallo, Laval (CA); Taimoor Abbas, Sainte-Julie (CA); Atle Monrad, Froland (NO); Debashish Purkayastha, Eagleville, PA (US)

(73) Assignee: InterDigital Patent Holdings, Inc., Wilmington, DE (US)

(21) Appl. No.: 19/092,953

(22) Filed: Mar. 27, 2025

(51) Int. Cl. H04W 8/08; H04W 8/26; H04W 12/037

(52) U.S. Cl. CPC H04W 8/08; H04W 8/26; H04W 12/037

(57) ABSTRACT

Methods for access network exposure are described herein. A method performed by a first network node may include receiving a first message including an identifier associated with a radio access network (RAN) node, sending a second message to a second network node, the second message including the identifier associated with the RAN node, and receiving a third message from the second network node. The third message may include non-access stratum (NAS) key information associated with one or more WTRUs. The method may include receiving a fourth message from a requesting WTRU, the fourth message including an encrypted NAS payload and decrypting the encrypted NAS payload using security context information to obtain content of the fourth message. A fifth message may be sent to a destination network function endpoint based on the content of the fourth message. A sixth message may be received from the determined network function in response.

### BACKGROUND

The 5G Core (5GC) network architecture establishes a framework designed to efficiently manage communication, security, and mobility within 5G networks. Network functions within the 5GC communicate directly through the Service Bus Interface (SBI). SBI-exposed functions utilize this interface for direct interaction. The Radio Access Network (RAN) interacts with the 5GC through designated reference points. Notably, the RAN itself does not directly interface with the SBI; hence, all incoming signaling from Wireless Transmit/Receive Units (WTRUs) and RAN nodes requires processing through an Access and Mobility Function (AMF).

WTRUs may establish communication with the 5GC via the N1 reference point, also terminating at the AMF. The N1 interface carries Non-Access Stratum (NAS) signaling, which handles control-plane messages critical for functions such as mobility management and authentication. These NAS messages are encrypted using NAS security keys. Consequently, the encrypted NAS signaling transiting through the RAN remains secure and invisible to RAN nodes.

### SUMMARY

Methods for access network exposure are described herein. A method performed by a first network node may include receiving a first message including an identifier associated with a radio access network (RAN) node, sending a second message to a second network node, the second message including the identifier associated with the RAN node, and receiving a third message from the second network node. The third message may include non-access stratum (NAS) key information associated with one or more WTRUs. The method may include receiving a fourth message from a requesting WTRU, the fourth message including an encrypted NAS payload and decrypting the encrypted NAS payload using security context information to obtain content of the fourth message. A fifth message may be sent to a destination network function endpoint based on the content of the fourth message. A sixth message may be received from the determined network function in response which may trigger sending a message to a WTRU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an exemplary 5G core network architecture according to one example;

FIG. 3 is a block diagram illustrating a possible evolution of a 5G core network architecture;

FIG. 4 is a block diagram illustrating one example of a 5GC architecture deployed using an SCP-AN or REF to expose a RAN to the CN service bus;

FIG. 5 is a signaling flow diagram illustrating an exemplary procedure for exposing the RAN to the CN service bus via an SCP-AN or REF;

FIG. 6 is a signaling flow diagram illustrating an exemplary procedure for enabling unsolicited downlink messages via an SCP-AN or REF; and

FIG. 7 is a signaling flow diagram illustrating an exemplary procedure for managing WTRU mobility aspects via an SCP-AN or REF.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

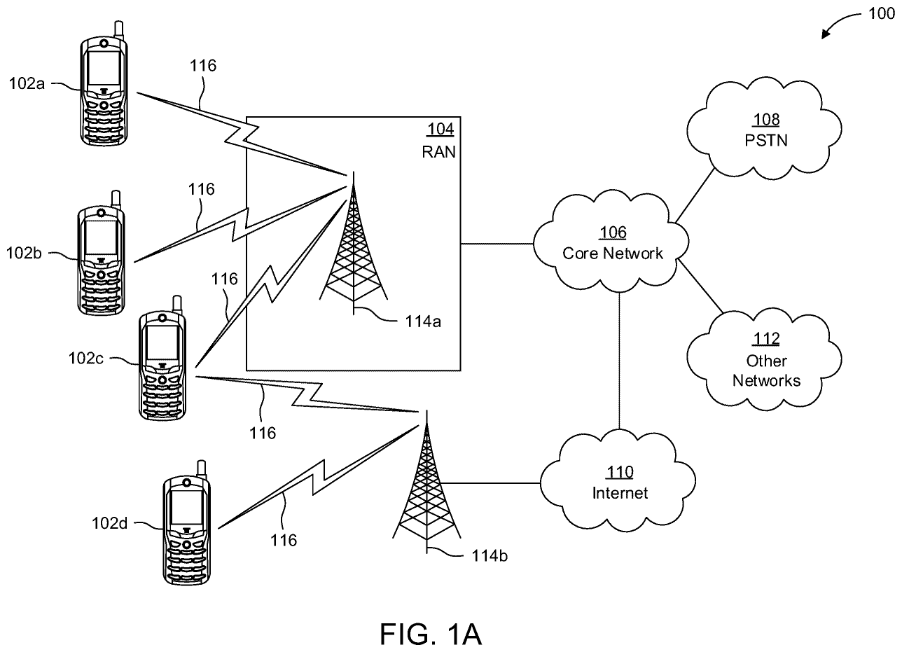

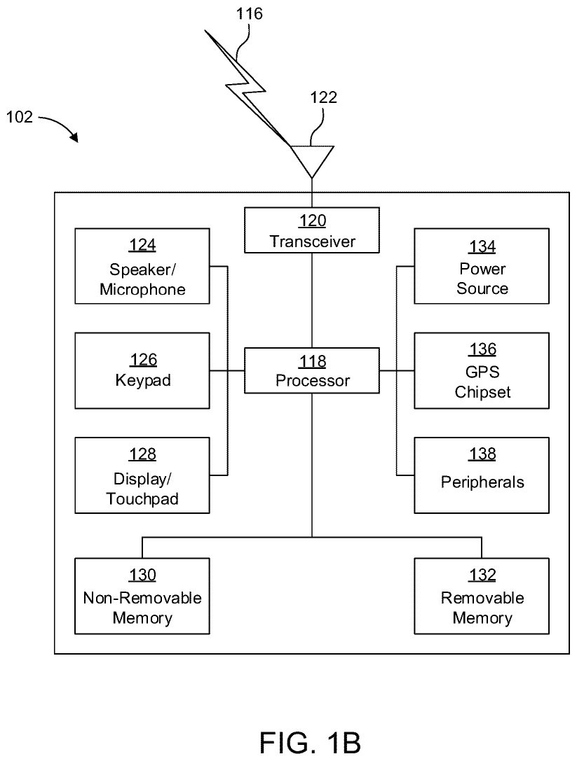

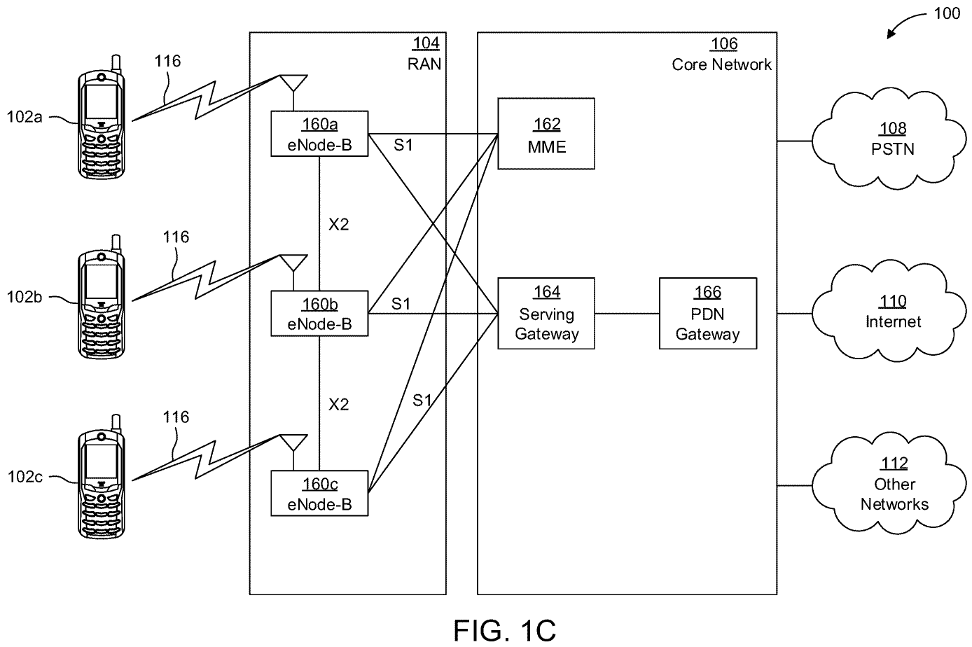

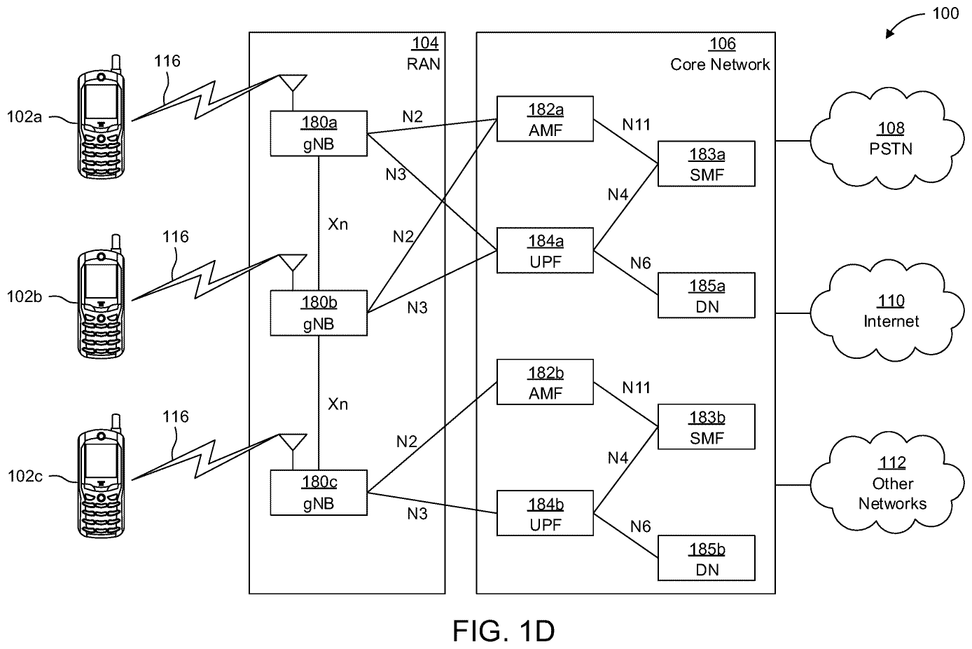

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80 +80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In the following description, various acronyms may be used. The acronym 5GS may be used to refer to the 5G System. The acronym 5GC may be used to refer to the 5G Core Network. The acronym ACK may be used to refer to Acknowledgement. The acronym AMF may be used to refer to the Access and Mobility Management Function. The acronym AN may be used to refer to the Access Network. The acronym CN may be used to refer to the Core Network. The acronym DL may be used to refer to Downlink. The acronym DN may be used to refer to Data Network. The acronym LTE may be used to refer to Long Term Evolution, for example, from 3GPP LTE Release 8 and later. The acronym NAS may be used to refer to Non-Access Stratum. The acronym NEF may be used to refer to Network Exposure Function. The acronym NF may be used to refer to Network Functions. The acronym NR may be used to refer to New Radio. The acronym NRF may be used to refer to Network Repository Function. The acronym PCF may be used to refer to Policy Control Function. The acronym RAN may be used to refer to Radio Access Network. The acronym REF may be used to refer to Radio Exposure Function. The acronym SB may be used to refer to Service Bus. The acronym SBI may be used to refer to Service Bus Interface. The acronym SCP may be used to refer to Service Communication Proxy. The acronym SCP-AN may be used to refer to Service Communication Proxy for Access Network. The acronym SMF may be used to refer to Session Management Function. The acronym TAI may be used to refer to Tracking Area Identifier. The acronym UDM may be used to refer to Unified Data Management function. The acronym UDR may be used to refer to Unified Data Registry. The acronym UE may be used to refer to User Equipment. The acronym UL may be used to refer to Uplink. The acronym UPF may be used to refer to User Plane Function.

An overview of the 5G core network architecture according to some solutions is provided herein.

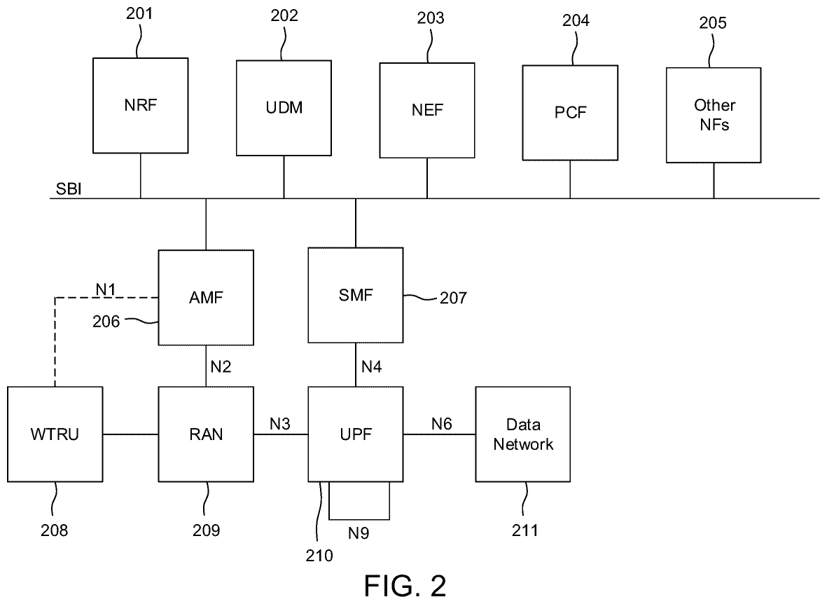

FIG. 2 is a diagram illustrating an exemplary 5G core network architecture according to one example. The 5G Core (5GC) network architecture in FIG. 2 illustrates that network functions within the 5GC are able to communicate via a Service Bus Interface (SBI); in other words, FIG. 2 demonstrates that network functions exposed to the SBI may communicate directly via the SBI. The 5GC includes an NRF 201, a UDM 202, a NEF 203, a PCF 204, other NFs 205, as well as the AMF 206 and SMF 207. The architecture shown in FIG. 2 further includes a WTRU 208, a RAN 209, a UPF 210 and a Data Network (DN) 211. It should be understood that the architecture shown in FIG. 2 may include one or more of each of the elements shown.

As shown in FIG. 2, the Radio Access Network (RAN) 209 communicates with the 5GC via the N2 reference point and N2 communication is terminated at the AMF 206. In this example, the RAN 208 is not exposed to the SBI and all messaging (e.g., from WTRUs or RAN nodes) may need to be processed at the AMF 206.

As shown in FIG. 2, the WTRU 208 may communicate with the 5GC via the N1 reference point and the N1 reference point is terminated at the AMF 206. N1 messages may contain NAS signaling (e.g., control plane) which is encrypted using NAS security keys. NAS security keys are issued based on a NAS security context which is established between the WTRU 208 and the AMF 206 at WTRU registration. In other words, N1 messages that include NAS signaling are exchanged between the WTRU 208 and AMF 206 via RAN 209, but RAN 209 may not have visibility into the encrypted NAS signaling.

Considering that there may be a plurality of WTRUs for each RAN node and a plurality of RAN nodes to provide coverage for a region, it becomes apparent that the AMF may be a critical communication point of this architecture, and that the AMF may experience overloading conditions.

In the example of FIG. 2, the RAN 209 may communicate with the UPF 210 via the N3 reference point and the UPF 210 may communicate with one or more Data Networks 211 via the N6 reference points. User data (e.g., user plane data) may be exchanged over the N3 and N6 reference points between RAN 209 and Data Networks 211.

The UPFs 210 can inter-communicate (e.g., communicate with each other) via the N9 reference point and can communicate with the SMF 207 via the N4 reference point.

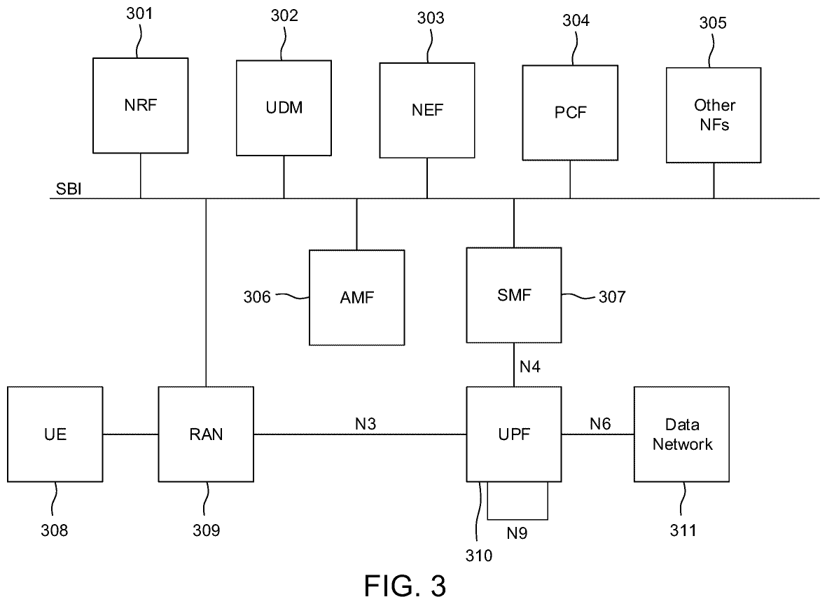

FIG. 3 is a block diagram illustrating a possible evolution of a 5G core network architecture. Similar to the architecture shown in FIG. 2, describe above, the 5GC includes an NRF 301, a UDM 302, a NEF 303, a PCF 304, other NFs 305, as well as the AMF 306 and SMF 307. The architecture shown in FIG. 3 further includes a WTRU 308, a RAN 309, a UPF 310 and a Data Network (DN) 311. It should be understood that the architecture shown in FIG. 3 may include one or more of each of the elements shown. In the evolution illustrated in FIG. 3, RAN nodes 309 are exposed to the SBI and messaging (e.g., from WTRUs or RAN nodes 208) does not need to be processed at the AMF; in other words, RAN messages may be exchanged with network functions without involving the AMF. This possible evolution suggests that directly exposing directly RAN nodes to the 5GC SBI may resolve the AMF communication overloading conditions described above. However, this architecture evolution also does present challenges which are further described herein.

The NRF is described in greater detail herein. The NRF may act as a centralized service registry and provides a discovery mechanism for NFs. The NRF maintains an updated repository of available NFs and their supported services, allowing newly deployed NFs to register and existing ones to discover required services dynamically.

As part of NF discovery procedures, the NRF performs Network Function (NF) instance selection and may consider aspects such as service load, optimal service location, slice information and policies to ensure secure and efficient service discovery.

The NRF may communicate with other NFs over the Service-Based Interface (SBI) via HTTP and/or RESTful APIs.

Service Communication Proxies (SCPs) are described in greater detail herein. An SCP may act as an intelligent intermediary for signaling traffic between NFs and may works in conjunction with the NRF.

The SCP may play a role in message dispatching to available NF instances to ensure optimal utilization of network functions, can enforce authentication/authorization/traffic filtering policies to secure inter-NF communication and can buffer and retry requests to improve network robustness.

The SCP instances may abstract NF endpoint details to reduce complexity in service communications and facilitate scalable/dynamic deployments. In other words, a SCP may be deployed for a specific service (e.g., which may have multiple deployed server instances) and the SCP may act as an entry point for accessing that service (e.g., any server instance) by providing load balancing, security and reliability aspects.

The SCP may communicate with other NFs over the Service-Based Interface (SBI) via HTTP and RESTful APIs.

Those of ordinary skill in the art will appreciate that the SCP may be discovered via the NRF and that discovering a NF using the NRF may result in obtaining (or identifying) the SCP that is associated with that NF. The user of the NF obtains the endpoint of the SCP to communicate with the NF and does not (or may not) know that the obtained endpoint is a SCP (e.g., the SCP is transparent to the NF user).

One or more problems and challenges, which may be addressed by one or more solutions presented and described herein.

In existing architectures, the AMF has become a communication bottleneck in the 5G system due to its centralized role. The AMF may handle all the NAS signaling related to mobility management, session management and security for all WTRUs which may cause the AMF to become overloaded in networks with high WTRU density.

For example, mobility and session management signaling (e.g., handovers, TA updates, etc.) generate multiple NAS messages that must be processed at the AMF. As such, frequent and quick location changes may be experienced, for example in urban areas (e.g., public transport and automotive), which may cause frequent location updates that impact the AMF's responsiveness. Further, scaling the AMF dynamically to address overload use cases may be complex and inefficient, making this potential solution nearly impossible to achieve for real-time scenarios. As such, it is apparent when designing the 6G system that changes are required to find solutions to address (e.g., reduce, eliminate) issues stemming from the AMF's role as a central node.

One possible approach to address these issues may be to expose the Radio Access Network (RAN) to the Core Network (CN) service bus such that the RAN is capable of communicating directly with Network Functions exposed on the CN service bus.

While this approach may remove the AMF bottleneck, it presents challenges. A first challenge may be related to the security context established between a WTRU and the AMF for exchanging NAS messages. This security context is desirable to protect sensitive WTRU information exchanged with the AMF, and the encrypted NAS messages are not decipherable by RAN nodes which makes it impossible for RAN to determine the target NF. Furthermore, complexities associated with the CN would be exposed to the RAN which would create an unnecessary coupling between RAN and CN domains.

A second challenge is related to the system's scalability. It may be difficult or even impossible to scale RAN nodes dynamically, and handling NAS traffic within the RAN might not permit the system to scale in overload cases. Further, it is expected that CN scaling may be facilitated in 6G systems, which may create an additional coupling between RAN and CN, necessitating tracking of CN changes dynamically.

Thus, a secure and scalable solution is needed for enabling dispatching NAS messages directly to NF(s) when the RAN is exposed to the CN service bus without creating extra coupling between the CN and RAN domains.

Solutions that may address one or more problems or challenges mentioned above are described. Specifically, solutions may provide mechanisms for exposing RAN nodes to the CN via enhanced Service Communication Proxy for AN (e.g., SCP-AN) or via a RAN Exposure Function (REF). The differences between SCP-AN and REF are described in further detail herein. An SCP-AN/REF may be referred to herein as a network function, a first network function, a service, or a first service. The term SCP-AN/REF may refer to a function, a service, an algorithm or a set of algorithms that is executed by a processor, circuitry, or other computing hardware in a network node, which may be a server, a base station, or other network infrastructure equipment.

Solutions for exposing RAN to the CN via an enhanced Service Communication Proxy for AN (SCP-AN) or via a RAN Exposure Function (REF) may include one or more procedures and methods for registering SCP-AN or REF instances with the NRF; discovering SCP-AN or REF instances with the NRF; configuring SCP-AN or REF instances based on a WTRU NAS security context; performing NAS to SBI message conversions; selecting NF(s) for dispatching SBI messages; handling of solicited and unsolicited downlink messages; and/or reconfiguring SCP-AN or REF instances on WTRU mobility events. A particular solution may involve one or a combination of multiple procedures or methods.

An SCP-AN/REF may be a scalable and efficient solution to expose the RAN domain nodes directly to the CN domain nodes via the CN service bus.

Herein, a service bus may be a functional entity allowing NFs to communicate with each other. A service bus may be implementation specific. A service bus may be any means allowing NFs to communicate with each other. A NF may communicate with other NFs via a service bus or a NF may communicate with a service bus to reach another NF. The terms ‘communicating with a service bus’ or ‘communicating via a service bus’ may be used interchangeably.

The NAS protocol and NAS security context described herein is used as an example of a protocol for exchanging control messages between a WTRU and a mobile network. Dependent on mobile network evolution, new protocol may be adopted for exchanging control messages between a WTRU and a network. As such, those of ordinary skill in the art will appreciate that the concepts of NAS control messages and the NAS security context for exchanging control messages between a WTRU and a mobile network may be equally applicable to different protocols (e.g., existing and future) for the exchange of control messages. Those of ordinary skill in the art will appreciate will further appreciate that a control message may be a message exchanged between a WTRU and a functional entity within a mobile network, that a control message may originate from a WTRU and be terminated at a functional entity within a mobile network, that a control message may originate from a functional entity within a mobile network and be terminated at a WTRU, and that the exchange of a control message between a WTRU and a functional entity of a mobile network may happen via any communication plane provided by the mobile network (e.g., a control plane, a data plane, etc.).

Terminology applicable to one or more solutions is defined in greater detail herein. A CN domain may refer to a logical subdivision of the network that comprise some or all functional entities within the Core Network (e.g., AMF, SMF, UPF, PCT, UDM/UDR, NRF, NEF, etc.). A RAN domain may refer to a logical subdivision of the network that includes all functional entities composing the Radio Access Network (e.g., gNodeB, eNodeB, or other types of RAN nodes, base stations, or other network infrastructure equipment).

The terms Service Communication Proxy for Access Network (SCP-AN) and RAN Exposure Function (REF) may refer to similar functionality and may be used interchangeably in the description herein. Both functional entities (e.g., SCP-AN and/or REF) may require a service-based northbound interface (e.g., allowing a lower-level network component to communicate with a higher-level network component) to interact with the core network service bus over SBI. The southbound interface (which may allow a higher-level network component to communicate with a lower-level network component) with the RAN, however, may be either service-based or RAN-specific or a dedicated interface (e.g., using point-to-point interface, using a Stream Control Transmission Protocol (SCTP)). A SCP-AN may require a southbound interface that is service-based while a REF may support either a service-based or RAN-specific southbound interface. Since a RAN may evolve towards a service-based interface or continue to use a RAN-specific interface, the functionality described hereinafter may be implemented as a Service Communication Proxy for Access Network (SCP-AN) or RAN Exposure Function (REF) depending on RAN evolution.

SCP-AN/REF discovery refers to discovering a SCP-AN or REF instance. SCP-AN/REF discovery may be a service endpoint provided by a NRF to discover SCP-AN or REF instances to be used by a RAN node. It can be appreciated that the NRF already provides a service endpoint for NF discovery that allows to discover NF instances available in the core network. Thus, it can be appreciated that the service discovery endpoint for a SCP-AN/REF instance may be provided via the NF discovery service endpoint and that the term SCP-AN/REF discovery and NF discovery may be used interchangeably.

Principles relating to architectural and deployment options are described herein. The SCP-AN or REF may follow principles defined herein.

A first principle may be related to SCP-AN or REF deployment. The SCP-AN or REF may be deployed in the CN as a bi-directional proxy to marshal uplink and downlink signaling exchanged between the CN and RAN domains. More specifically, the SCP may be deployed as a communication proxy (e.g., or alternatively as a NF) dispatching uplink signaling originating from the WTRU and/or the RAN domain and entering the CN domain and additionally dispatching downlink traffic originating from the CN domain and sent towards a WTRU and/or the RAN domain. The SCP-AN or REF may therefore be deployed as a proxy node which is in the CN trust domain and isolates the RAN domain from details and complexities of the CN deployment while providing communication dispatching, security, and reliability aspects.

A second principle is related to SCP-AN or REF cardinality. There may be one or more SCP-AN or REF instance(s) in the system. In a first example, a Mobile Network Operator (MNO) may favor a centralized deployment by deploying (e.g., a single) SCP-AN or REF instance for the whole PLMN. In a second example, an MNO may favor a distributed SCP-AN or REF deployment by deploying a SCP-AN or REF instance for each RAN node (e.g., gNodeB). In a third example, an MNO may favor a regional deployment by deploying a SCP-AN or REF instance for a group of RAN nodes. Further, SCP-AN or REF deployments may be realized as a static deployment, when the SCP-AN or REF instances are pre-determined, or may be realized as a dynamic deployment, when the network has the capability of scaling up or down the number of SCP-AN or REF instances. To address network scalability, it is more likely that dynamic SCP-AN or REF deployments can be realized in comparison to dynamic AMF deployments due to the simpler function of the SCP-AN or REF compared to the AMF.

A third principle is related to SCP-AN or REF discovery. SCP-AN or REF may register to the NRF, and the RAN domain nodes may have a capability to access the NRF for discovering the SCP-AN or REF availability. SCP-AN or REF instances can register to the NRF and may be discovered by the RAN nodes. The NRF may have capabilities to identify the RAN node requesting SCP-AN or REF discovery and may provide to the requesting RAN node the SCP-AN or REF instance(s) that should be used by that RAN node (e.g., dependent on SCP-AN or REF cardinality/assignment rules and the network capabilities for dynamic SCP-AN or REF scaling).

A fourth principle is related to SCP-AN or REF capabilities. The traditional SCP does not have capabilities to expose the RAN domain nodes to the CN domain nodes, thus a SCP-AN or REF may be a SCP that is enhanced with new capabilities to provide RAN domain node exposure to the CN.

A first SCP-AN or REF capability may be to enable SCP-AN or REF to decrypt uplink NAS traffic originating from the WTRU for the purpose of dispatching messages to CN domain nodes, and a capability to encrypt downlink NAS traffic from the CN domain nodes for the purpose of dispatching messages towards the WTRU.

A second SCP-AN or REF capability may be to enable the SCP-AN or REF to perform NAS to SBI conversions. The NAS payload can be converted to form SBI message(s) that may be sent towards the CN domain nodes, and conversely the SBI message(s) payload can be converted to NAS payload that may be sent towards the WTRU.

A third SCP-AN or REF capability may be to enable the SCP-AN or REF to be dynamically configured with a set of rules (e.g., Dispatch Rules) for dynamically controlling the dispatching behavior between the RAN domain and the CN domain. The dynamic dispatch rules may allow the SCP-AN or REF to adopt a variable message dispatching behavior based on variable conditions. Dispatch rules may influence the SCP-AN or REF message dispatching behavior by considering factors such as the WTRU identity, User subscription, RAN node, NAS payload, Network Function.

In a first example, a dispatch rule may indicate that certain NAS messages should be dispatched to the AMF because they are still handled by the AMF (e.g., support for 6G evolution or varied deployments/capabilities).

In a second example, a dispatch rule may indicate that NAS messages associated with a WTRU or user subscription should be dispatched to certain CN domain node instances (e.g., support for tiered deployment options).

In a third example, a dispatch rule may indicate that NAS messages received from a RAN domain node should be dispatched differently than a RAN message received from another RAN node (e.g., support for RAN node capabilities).

In a fourth example, a dispatch rule may indicate that NAS messages destined for a CN domain node should be dispatched to different CN domain nodes based on a context (e.g., support for NF load, instance(s) availability, time, location, etc.).

It can be appreciated that more examples of possible dispatch rules are possible and that the enhanced capability described in this solution centers around the configurability and management of the dynamic dispatch rules.

It can be appreciated that the SCP-AN/REF may dispatch SBI messages sent from a RAN note towards a network functions (e.g., if the RAN node has SBI communication capabilities), and that the SCP-AN/REF may translate to SBI format NAS messages received by the RAN node and then dispatch such message towards a network functions.

A fourth SCP-AN or REF capability may be to enable the SCP-AN or REF to be dynamically configured with Instance/Domain Mapping Rules which may enhance other rules (e.g., Dispatch Rules) or be provisioned to be logically independent from other rules (e.g., Dispatch Rules). The Instance/Domain Mapping Rules may allow the SCP-AN or REF to determine the NF instance or CN domain for dispatching uplink NAS traffic originating from the WTRU. The instance/domain rules are deployment-dependent and may be used independently from the dispatch rules in order to allow independent management of the deployment (i.e. by an authorized party different than the MNO) from the logical traffic flow between RAN and CN entities (as reflected by the Dispatch rules). The Instance/Domain Mapping Rules may also implicitly or explicitly provide mappings between the SCP-AN or REF and its RAN nodes, effectively codifying the (second principle) cardinality applicable to a specific deployment. It can be appreciated that the Instance/Domain Mapping Rules may also be implemented as extensions of other network or deployment rules or policies, including the Dispatch Rules. It can also be appreciated that different implementations may employ different strategies for distributing such rules or policies, e.g. via static pre-provisioning, using network management procedures, using dynamic policy provisioning/distribution mechanisms, etc; for example, such as the policy provisioning procedures provided by a PCF.

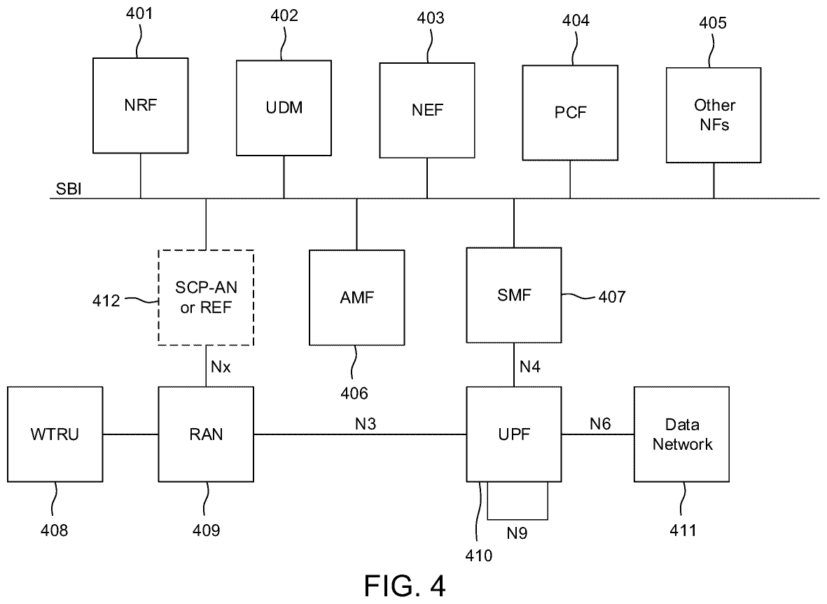

FIG. 4 is a block diagram illustrating one example of a 5GC architecture deployed using a SCP-AN or REF to expose RAN to the CN service bus. Similar to the architectures shown in FIG. 2 and FIG. 3, described above, the 5GC includes an NRF 401, a UDM 402, a NEF 403, a PCF 404, other NFs 405, as well as the AMF 406 and SMF 407. The architecture shown in FIG. 3 further includes a WTRU 408, a RAN 409 (e.g., one or more RAN nodes), a UPF 410 and a Data Network (DN) 411. The SCP-AN/REF 412 is deployed between the RAN and the 5GC, communicating with NFs within the 5GC via the SBI. It should be understood that the architecture shown in FIG. 4 may include one or more of each of the elements shown.

In the proposed example, RAN nodes 409 can discover the SCP-AN/REF 412 with the NRF 401 via the service bus and the NRF 401 can provide RAN nodes 409 with instance(s) of SCP-AN or REF 412 (e.g., dependent on implementation) as a result of SCP-AN/REF discovery. For example, a RAN node 409 may be pre-configured (e.g., by a management system) with the endpoint address of a NRF 401 and may be capable of sending a SCP-AN/REF discovery message directly to the NRF 401 via the service bus (e.g., before the SCP-AN or REF is discovered) to discover the SCP-AN or REF instance. The NRF 401 may be configured to provide an endpoint of a SCP-AN or REF 412 when a RAN node 409 discovers a NF. It can be appreciated that the NRF 401 may provide a SCP-AN or REF 412 to a RAN node 409 on the basis that the discovery message directly to the NRF 401 on the basis that the NF indicated in the discovery message is for a SCP-AN or REF or on the basis that the discovery message is originating from a RAN node (e.g., regardless of the NF indicated in the discovery message).

The NRF configuration effectively encodes the SCP-AN or REF deployment cardinality (e.g., as enunciated in the second principle). An NRF may be configured using Instance/Domain Mapping Rules (similarly to SCP-AN or REF 412) or via mappings (e.g., more limited mappings) between each SCP-AN or REF and its associated RAN nodes; examples of possible deployment cardinalities are described next.

A first exemplary deployment may be a global deployment where a single SCP-AN or REF instance is servicing all RAN nodes and is used for all network functions. In such a deployment, the NRF may provide the same endpoint to all RAN nodes when a SCP-AN/REF discovery happens with the NRF and the SCP-AN or REF may be configured with a set of dispatch rules for handling and dispatching the messages coming from RAN to the appropriate NF.

A second exemplary deployment may be a regional deployment where one or more SCP-AN or REF instances are servicing a subset (e.g., one or more) of the RAN nodes for all network functions. In such a deployment, the NRF may provide a first endpoint to a first group (e.g., one or more) of RAN nodes when a SCP-AN/REF discovery happens with the NRF and may provide a second endpoint to a second group (e.g., one or more) of RAN nodes when a SCP-AN/REF discovery happens with the NRF. Each SCP-AN or REF instance may be configured with a set of dispatch rules for handling and dispatching the messages coming from a RAN group to the appropriate NF, and the rules provided to each SCP-AN or REF instance may be different.

A third exemplary deployment may be a micro deployment where a SCP-AN or REF instance is servicing each WTRU for all network functions. In other words, a given WTRU is assigned to a single SCP-AN or REF instance to enable all authorized communications between the WTRU and network functions. In such a deployment, the NRF may provide a different endpoint for each WTRU that is camped on a RAN node when a SCP-AN/REF discovery happens with the NRF, and the same RAN node may therefore receive several SCP-AN or REF endpoints (e.g., one per WTRU). Each SCP-AN or REF instance may be configured with a set of dispatch rules for handling and dispatching the messages coming from a RAN node (e.g., per WTRU) to the appropriate NF, and the rules provided to each SCP-AN or REF instance may be different (e.g., per WTRU).

Those of ordinary skill in the art will appreciate that other deployments are possible and that the exemplary deployments could further be segmented per network function (e.g., one SCP-AN or NF per network function).

Once one or more SCP-AN or REF endpoint(s) have been discovered, the RAN may communicate via the CN service bus by sending messages to the SCP-AN or REF southbound interface using the endpoint obtained via the SCP-AN/REF discovery with the NRF. The SCP-AN or REF instance associated with an endpoint handles and dispatches messages to determined NF(s) via the SBI according to the dispatch rules as described hereinafter.

Methods for exposing a RAN (e.g., one or more RAN nodes such as gNodeBs, base stations, or other RAN infrastructure) on the CN service bus are described herein.

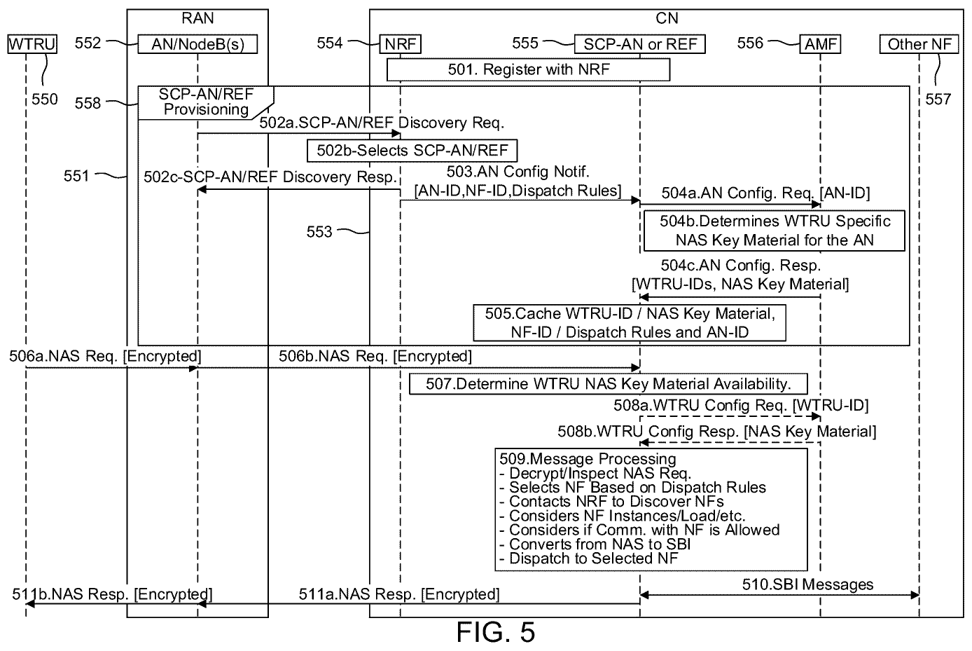

FIG. 5 is a signaling flow diagram illustrating an exemplary procedure for exposing the RAN to the CN service bus via a SCP-AN or REF. The procedure illustrated in FIG. 5 may involve signaling between a WTRU 550, AN/NodeB(s) 552 of a RAN 551, and network functions of a CN 553 include an NRF 554, an SCP-AN or REF 555, an AMF 556, and/or one or more other network functions 557. In the procedure illustrated in FIG. 5, messages illustrated and described herein may be described as a specific type of message (e.g., a “discovery” message, a “request” message, or a “response” message). However, those of ordinary skill in the art will appreciate that such messages may be referred to using other names, and a designation relating to the ordering of message (e.g., specifying that a given message is a “first message”, which is succeeded by a “second message” and later by a “third message”) may also be appropriate.

In step 501, the SCP-AN or REF 555 may register with the NRF 554. For example, the SCP-AN or REF 555 may be instantiated by the management system of the 5GS (e.g., a system or node handling creation and management of functional entities over the CN 553) and may be configured to register with the NRF 554 upon instantiation. Registration with the NRF 554 may include an identifier of a SCP-AN or REF instance, a NF type (e.g., SCP-AN type, REF type), endpoint information (e.g., FQDN, URI, IP address, port, etc.) and a PLMN identifier. The registration may further include NF service(s) identifiers that the SCP-AN or REF 555 is supporting, deployment information (e.g., global deployment, regional deployment, micro-deployment, RAN node(s) identifier(s), region identifier(s), WTRU identifier(s), etc.) that assists the NRF 554 with SCP-AN/REF discovery request handling and dispatching rules that the SCP-AN or REF 555 follows when handling and dispatching messages to the service bus. Upon receiving the registration information, the NRF 554 stores the information in a NF instance profile and makes the SCP-AN or REF 555 available for discovery.

The NRF 554 may store the provided registration information and make the registering SCP-AN or REF 555 available for discovery. The NRF 554 may return an indication of the registration status and a registration identifier for the management of the registration.

A sub-procedure for SCP-AN/REF provisioning is illustrated in FIG. 5 at 558. The sub-procedure for SCP-AN/REF provisioning includes one or more steps described herein. In step 502a and 502b, a RAN node 552 within a RAN 551 discovers a SCP-AN or REF (e.g., the SCP-AN or REF 555) that is available with (or registered with) the NRF 554. The RAN node 552 sends a SCP-AN/REF discovery request (as shown at 502a) to the NRF. The request may include information about the RAN node 552, such as the RAN node identifier (e.g., gNB ID) and Tracking Area Identity (TAI), information about the NF for which the discovery request is sent and may include additional information such as a RAN node group identifier, a RAN node location, or one or more WTRU identifiers. It can be appreciated that the NF identifier included in the request may be the identifier of a SCP-AN or REF 555 or another NF that the RAN node 552 wants to access. It can further be appreciated that the one or more WTRU identifiers may be the WTRUs that are already camped on the RAN node 552.

Upon receiving the request, as shown at step 502b, the NRF 554 selects a SCP-AN or REF instance for servicing the RAN node 552. The information included in the request may be used by the NRF 554 to identify the SCP-AN or REF 555 that is to be provided to the requesting RAN node 552. For example, the NRF 554 may use the NF service identifier, RAN node identifier(s) and WTRU identifier(s) from the request, along with the NF service identifier(s), deployment information and WTRU identifier(s) from the registration to identify whether a SCP-AN or REF instance should be used to access the requested NF, and the NRF 554 may return the endpoint of a SCP-AN or REF if it determines that the requested NF should be accessed via a SCP-AN or REF, thus inserting a SCP-AN or REF in the communication path of the RAN node 552 with the SBI. The NRF 554 sends a SCP-AN/REF discovery response as shown at step 502c to the requesting RAN node 552 and includes information associated with the selected SCP-AN or REF instance, including the SCP-AN or REF instance profile, identifier and endpoint.

It can be appreciated that the NRF 554 may establish and store an association between the RAN node instance (e.g., RAN node 552 performing the discovery) and the selected SCP-AN or REF instance 555 for servicing that RAN node 552. This association may be used by a NF instance in procedures that require to discover SCP-AN or REF instance which may be associated with a RAN node and/or a WTRU (e.g., WTRU 550) that is camped on a RAN node 552 (i.e., camped within a cell associated with the RAN node 552).

In step 503, the NRF 554 notifies the selected SCP-AN or REF 555 about its selection for servicing the RAN node 552. The NRF 554 sends an AN configuration notification to the selected SCP-AN or REF 555. The notification may include the AN identifier for which the SCP-AN or REF 555 was selected, NF identifier(s) indicated in the NF discovery request shown at 502c and may include additional information such as the AN group identifier, WTRU identifier(s) and dispatch rules that may be applicable. Upon receiving the notification, the SCP-AN or REF 555 may store the information included in the request in a memory cache to be used when handling and dispatching messages received from the RAN node 552.

In step 504, the SCP-AN or REF 555 obtains NAS security context information from the AMF 556 (as shown in FIG. 5) or from some other NF 557 in charge of maintaining the NAS security context; it may be appreciated that the 5G core network evolution may lead to the AMF 556 not managing NAS security context anymore and that the NAS security context information may be obtained from a dedicated NF in future core network evolution. The SCP-AN or REF may send an AN configuration request (as shown in step 504a) to the AMF 556, and the request may include the RAN node identifier and WTRU identifier(s) if provided in step 503. Upon receiving the request, the AMF 556 may determine, as shown in step 504b, WTRU specific NAS key material, including the WTRU NAS decryption key and NAS count. The AMF 556 may use the RAN node identifier to identify the WTRU(s) camped on the RAN node 552 (which may include WTRU 550) and determine the NAS key material for these WTRU(s). Additionally, if the request includes WTRU identifier(s), the AMF 556 may determine the NAS key material for these WTRU(s). The AMF 556 sends an AN configuration response 504c to the requesting SCP-AN or REF and includes the NAS key material for each WTRU identifier. Additionally, if the request included multiple RAN node identifier(s), the response may indicate the RAN node identifier where each WTRU is camped which may be useful for the SCP-AN or REF 555 to handle and dispatch messages coming from the RAN node 552.

As the WTRU temporary identifier (e.g., GUTI) may be updated periodically by AMF 556 for privacy reasons, the SCP-AN or REF 555 (e.g., implicitly) subscribes for WTRU temporary (e.g., GUTI) updates. The SCP-AN or REF 555 receives the WTRU temporary identifier associated with the WTRU long term identifier (SUPI) from AMF when a change occurs. As the NAS keys may be updated between the WTRU 550 and AMF 556 in some procedures (e.g., due to re-authentication, horizontal key derivation during change of AMF 556, the SCP-AN or REF 555 (e.g., implicitly) subscribes for NAS key material updates. The AMF 556 notifies the SCP-AN or REF 555 about the change prior to sending the new WTRU temporary identifier to the WTRU 550. This is needed to ensure that SCP-AN or REF 555 has an up-to-date WTRU temporary ID when receiving a new NAS request from the WTRU (shown in step 506, described in further detail below). Similarly, the AMF (e.g., a new serving AMF not illustrated separately from the AMF 556 shown in FIG. 5) notifies the SCP-AN or REF 555 during change of NAS keys procedure.

It can be appreciated that to provide replay protection, a NAS count (e.g., counter) may be used. A WTRU and an AMF may maintain individual NAS count. A NAS count may be included in a NAS message (e.g., either by the WTRU 550 or the AMF 556 in the example of FIG. 5), and the receiving entity may validate if the received NAS count is greater than the last received NAS count (e.g., for a given WTRU and NAS security context). Two possible examples for implementing or using the NAS count by an SCP-AN or REF are described herein.

In a first possible example for implementing or using a NAS count in SCP-AN or REF, the NAS count may be maintained at the AMF and the SCP-AN/REF may obtain from the AMF and update the AMF with a NAS count on every NAS message received or sent, and the AMF may validate the NAS count integrity for the messages received by the SCP-AN/REF.

In a second possible example for implementing or using a NAS count in SCP-AN or REF, the NAS counter may be decoupled from the AMF and maintained at the SCP-AN/REF (e.g., a different NAS count counter than the one at the AMF). Considering the decoupled approach, it can be appreciated that every instance of a SCP-AN/REF may have its own instance of a NAS counter and that a WTRU may send a nonce (e.g., a counter) in every uplink request, and the SCP-AN/REF may send another nonce (e.g., counter) in the DL direction such that replay protection may be achieved by the WTRU and the SCP-AN/REF by validating each other counter values to detect replayed messages.

It can further be appreciated that a NAS count may be enhanced by coupling or correlating the NAS count at the SCP-AN/REF with the SCP-AN/REF identifier and/or RAN node identifier such that the NAS counts maintained at each SCP-AN/REF instance can be differentiated.

Further with respect to the example of FIG. 5, in step 505, upon receiving the response, the SCP-AN or REF 555 may store the information included in the response in a memory cache to be used when handling and dispatching messages received from the RAN node 502.

In steps 506a and 506b, the WTRU 550 may perform a procedure with the network which may require a NAS message to be sent. The WTRU 550 sends a message (as shown at step 506a) including an encrypted NAS payload. The message is received at the RAN node 552 (e.g., on which the WTRU 550 is camped) and the RAN node 552 determines to send the message (as shown at step 506b) on the core network service bus based on the presence of encrypted NAS payload. To send the message on the core network service bus, the RAN node 552 sends the message to the SCP-AN or REF endpoint obtained in steps 502a and 502b and 502c. It can be appreciated that the RAN node 552 can be triggered to perform steps 502a and/or 502b by receiving a message with an encrypted NAS payload if it has not yet obtained an endpoint to communicate with the core network service bus. The message sent from the RAN node 552 at step 506b towards the SCP-AN or REF instance (e.g., the SCP-AN or REF 555) includes the NAS encrypted payload and may include a RAN node identifier and WTRU (e.g., temporary) identifier.

It may be assumed that the Access Stratum security is activated and the NAS message transported in a (e.g., RRC) message between the WTRU and RAN node is fully (confidentiality, integrity and replay) protected. The AS security may (re)activated during a procedure between the WTRU and AMF (e.g., registration or service request).

In step 507, upon receiving the message from the RAN node 552, the SCP-AN or REF 555 may determine if the RAN node 552 is authorized, and the authorization determination may be based on the notification sent in step 503. If the RAN node request is authorized, the SCP-AN or REF 555 may determine whether it has the necessary NAS key material to handle the request. The determination may be performed by using the information from the request and the information available in a memory cache of the SCP-AN or REF 555 and may be based on the RAN node identifier(s) and WTRU identifier.

In steps 508a and 508b, if the SCP-AN or REF 555 has determined that it does not have the required NAS key material or if it determines that the NAS key material should be refreshed, the SCP-AN or REF 555 may send a WTRU configuration request (as shown at step 508a) to the AMF 556, including the WTRU identifier. The AMF 556 upon receiving the request may determine the requested NAS key material for WTRU 550 indicated in the request, and may send a WTRU configuration response (as shown at step 508b) to the requesting SCP-AN or REF 555.

In step 509, the SCP-AN or REF 555 processes the incoming encrypted NAS message from the RAN node 552. Processing of the incoming encrypted NAS message may include one or more sub-steps, such as those described herein.

A first sub-step may include decrypting the NAS request using the NAS key material from the WTRU 550 and validating whether the NAS count included in the encrypted payload is coherent with the NAS count from the NAS key material. The sub-step may include incrementing the NAS count and/or notifying the AMF 556 about the NAS count increment. A result of the first sub-step may be that the SCP-AN or REF 555 determines a NF instance identifier, an NF pool identifier, or message type. The NF instance identifier, an NF pool identifier, or message type can then be used to determine a target NF instance. For example, if the message carries a PDU Session Modification request message, then the SCP-AN or REF 555 may need to determine an SMF or SMF pool to which to forward all or part of the message. For example, if the message carries a PDU Session Establishment request message, then the SCP-AN or REF 555 may need to determine that the message is a session management message and that an SMF or SMF pool needs to be selected to handle the request. Replay protection may be ensured by the SCP-AN or REF 555, for example, as described above with respect to steps 504a and 504b.

A second sub-step may include selecting a target NF instance to dispatching the message towards and this selection may be based on dispatch rules (e.g., pre-configured or configured) at the SCP-AN or REF 555. The NAS message type being processed and may allow to identify one or more NFs to dispatch the message towards; for example, dispatch rules may indicate that a network registration NAS message may be dispatched to an AMF or NF instance or that a session management NAS message may be dispatched to a SMF NF instance. Dispatch rules may further provide information to assist in the NF instance selection; for example, dispatch rules may indicate that any target NF instance may be selected or may indicate that a NF instance selection is based on RAN node identifier or a WTRU identifier (e.g., when NF is associated to RAN nodes or WTRUs) or may indicate how to identify the NF instance (e.g., by querying another NF) in cases where NF instance is dynamically associated with a WTRU. Dispatch rules may further provide information to assist in the NF instance selection; for example, when the NF processing load should be considered for selecting the NF instance or when load balancing rules apply in the NF instance selection.

Those of ordinary skill in the art will appreciate that when performing the second sub-step, the SCP-AN or REF 555 may communicate with other NF instances to help identifying a NF instance to dispatch the message to, and that the NF instance may be the NRF, for example to obtain existing or new NF instances profiles that may be considered in the NF instance selection.

Those of ordinary skill in the art will appreciate that when performing the second sub-step, the SCP-AN or REF may determine whether a RAN node is allowed to communicate with a NF instance (e.g., considering dispatch rules), and that communication with disallowed NF instances may be prevented by the SCP-AN or REF when appropriate.

A third sub-step may include converting the NAS message being processed into a service-based message to be dispatched to the selected NF instance. Dispatch rules may include information on the NF instance communication format capability; for example, a dispatch rule may indicate that a NF instance handles encrypted NAS messages (e.g., an AMF) or that a NF instance handles service-based messages or whether a NF instance is trusted or not. Dispatch rules may further indicate the expected security for communicating with the NF instance, for example whether secure tokens are expected in the SBI message.

Those of ordinary skill in the art will appreciate that communication with NF instances over the SBI may require security tokens for communication, and security tokens for SBI communication may be provisioned with the SCP-AN or REF 555 by another NF. For example, the SCP-AN or REF 555 may obtain security tokens for SBI communication from the NRF when performing NF discovery or from a dedicated NF responsible of managing SBI communication security contexts/tokens or may obtain such security tokens when it is provisioned with the dispatch rules (e.g., in step 503). In other words, a SCP-AN or REF may obtain SBI communication security tokens with the NRF or another NF in a similar way (e.g., steps 504a and/or 504b). For example, an SCP-AN or REF may obtain SBI communication security tokens when it obtains NAS key material with the AMF for the WTRU NAS security context.

In step 510, the SCP-AN or REF 555 dispatches the service-based message request to the target NF instance that has been determined in step 509. The content of the service-based message includes the SCP-AN or REF instance endpoint as the source of the message and may additionally include a SCP-AN/REF identifier, a RAN node identifier, WTRU identifier and a transaction identifier which is associated with the request. Additionally, the service-based message may include any information provided in the NAS message which was decrypted at the SCP-AN or REF 555 and which triggered the service-based message. Upon receiving the service-based message, the target NF processes the service-based message and returns a response to the SCP-AN or REF 555.

In steps 511a and 511b, the SCP-AN or REF 555 receives the service-based message response and may use the transaction identifier to identify the RAN node 552 and WTRU 550 that originated the service-based transaction. Using the transaction identifier, the SCP-AN or REF 555 may retrieve the NAS encryption key associated with the triggering WTRU 550 and may convert the service-based response to the NAS format before encrypting. The SCP-AN or REF 555 sends the NAS message response (as shown at step 511a) towards the RAN node 555, and the RAN node 552 sends the NAS message (as shown at step 511b) response towards the WTRU 550.

Methods and procedures for handling of unsolicited downlink messages are described herein. Different scenarios are considered for downlink messaging when RAN nodes are exposed to the SBI via a SCP-AN or REF.

A first scenario may involve sending a solicited downlink message (e.g., a response) from a NF towards a RAN node or WTRU when the downlink message is triggered by an uplink message (e.g., a request) as presented on FIG. 5. For such scenarios, the NF responds to a received request and sends the downlink message to the SCP-AN or REF from which the uplink message originated.

A second scenario may involve sending an unsolicited downlink message (e.g., a notification) from a NF towards a RAN node or a WTRU when the downlink message is triggered by an event, or a timer happening at the NF and is not solicited by the reception of an uplink message.

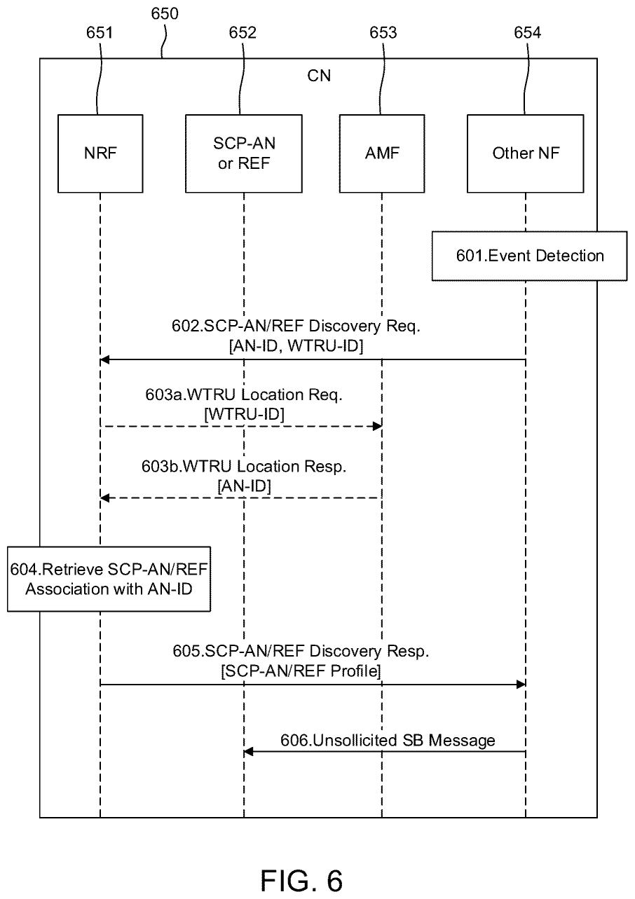

FIG. 6 is a signaling flow diagram illustrating an exemplary procedure for enabling unsolicited downlink messages via SCP-AN or REF. For the scenario of unsolicited downlink messages via a SCP-AN or REF, the NF may need to discover the SCP-AN or REF associated with a RAN node or a RAN node where a WTRU is camped. The procedure shown in the example of FIG. 6 involves signaling between functions within a CN 650 including an NRF 651, an SCP-AN or REF 652, an AMF 653, and one or more other NFs 654. In the procedure illustrated in FIG. 6, messages illustrated and described herein may be described as a specific type of message (e.g., a “discovery” message, a “request” message, or a “response” message). However, those of ordinary skill in the art will appreciate that such messages may be referred to using other names, and a designation relating to the ordering of message (e.g., specifying that a given message is a “first message”, which is succeeded by a “second message” and later by a “third message”) may also be appropriate.

As shown at step 601, an unsolicited event (e.g., an event, a received message, or the initiation or expiration of a timer) is detected by the triggering NF (e.g., NF 654) that requires the NF 654 to send a downlink message to a RAN node, or a WTRU camped on a RAN node.

In step 602, the triggering NF 654 sends a SCP-AN/REF discovery response to the NRF 651; the request may include the RAN node identifier(s) and/or WTRU identifier(s) along with indication that the discovery is for discovering the SCP-AN or REF information for communicating the RAN node or WTRU camped on the RAN node.

In step 603a, if WTRU identifier(s) are included in the request, the NRF 651 sends a WTRU location request (as shown in step 603a) to the AMF 653 to obtain the information on the RAN node where the WTRU(s) are camped. The request may include the WTRU identifier(s), and the response include the RAN node identifiers. The request to the AMF may not be necessary if the request does not include WTRU identifier(s) or if the NRF already has the information on where the requested WTRU(s) are camped. For example, the NRF may subscribe with the AMF exposure service (e.g., Namf_EventExposure) to obtain WTRU location reports which includes the RAN node identifier(s) and TAI where WTRU(s) are camped. If the NRF 651 sends the WTRU location request, the AMF 653 may send a response including the requested WTRU location information, as shown at 603b.

In step 604, the NRF 651 may determine the SCP-AN or REF 652 that is associated with the RAN node using the RAN node identifier (e.g., gNB ID or TAI) included in the request and based on an association made in another step (e.g., an association between RAN node and SCP-AN/REF). This may be consistent with step 502b of FIG. 5, described substantially herein.

In step 605, the NRF 651 sends a SCP-AN/REF discovery response to the requesting NF 654. The response may include SCP-AN or REF profile which includes the endpoint information that the triggering NF 654 may use to send the downlink message to the RAN node or to the WTRU camped on a RAN node.

In step 606, the triggering NF 654 sends the unsolicited service-based message towards the SCP-AN or REF included in step 605. The processing performed by the SCP-AN or REF upon receiving the message may be consistent with steps 510, 511a and/or 511b of FIG. 5, described substantially herein.

For cases where a WTRU in IDLE mode needs to be triggered by a NF to send an unsolicited downlink message, the WTRU paging procedure is required to wake up the WTRU from IDLE mode. The paging procedure may be triggered via the AMF 653 and, for example, message in step 603a may trigger the AMF 653 to page the WTRU.

Mobility aspects, including methods and procedures, are described herein. In some examples, WTRU mobility may cause the WTRU to transition from a source RAN node to a target RAN node. Camping on a target RAN node may cause the SCP-AN or REF associated with a WTRU to change when, for example, the target RAN node is not associated with the same SCP-AN or REF as the source RAN node. When mobility happens, it may be necessary to provide NAS key material to the SCP-AN or REF associated with the target RAN node.

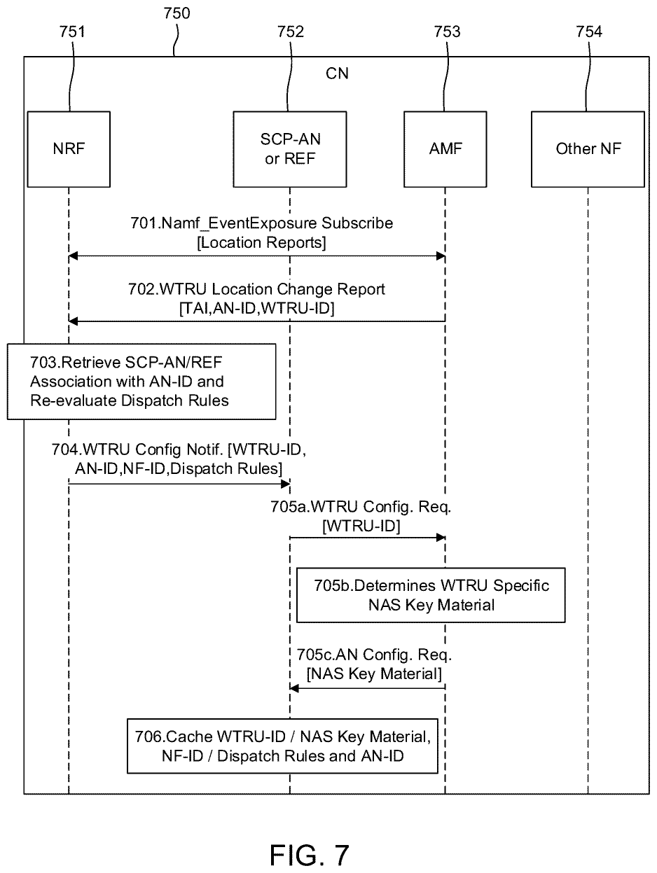

FIG. 7 is a signaling flow diagram illustrating an exemplary procedure for managing WTRU mobility aspects via SCP-AN or REF. The procedure shown in the example of FIG. 7 involves signaling between functions within a CN 750 including an NRF 751, an SCP-AN or REF 752, an AMF 753, and one or more other NFs 754. In the procedure illustrated in FIG. 7, messages illustrated and described herein may be described as a specific type of message (e.g., a “discovery” message, a “request” message, or a “response” message). However, those of ordinary skill in the art will appreciate that such messages may be referred to using other names, and a designation relating to the ordering of message (e.g., specifying that a given message is a “first message”, which is succeeded by a “second message” and later by a “third message”) may also be appropriate.

In step 701, the NRF 751 subscribes with the AMF exposure service (e.g., Namf_EventExposure) to obtain WTRU location reports which includes the new RAN node identifier(s) and TAI where WTRU(s) are camped after mobility happens.

In step 702, following a WTRU mobility event, the AMF 753 notifies the NRF 751 about a WTRU location change. The notification includes the WTRU identifier and the new TAI, and the target RAN node identifiers where the WTRU is now camped following mobility.

In step 703, the NRF 751 determines the new SCP-AN or REF (e.g., SCP-AN or REF 752) that is associated with the new RAN node using the RAN node identifier (e.g., gNB ID or TAI) included in the request. The determination may be further based on an association between a RAN node and the SCP-AN/REF, which may be consistent with step 502b of FIG. 5, described substantially herein. The NRF 781 may also determine the old SCP-AN or REF associated with the old RAN node using the WTRU identifier.

Although not shown on FIG. 7, the NRF 751 may also (or alternatively) invalidate dispatch rules associated with the old RAN node and send a notification to the old SCP-AN or REF to remove the NAS key material and dispatch rules associated with the WTRU identifier.

The NRF 751 may re-evaluate dispatch rules according to the reported change, for example if there are WTRU specific dispatch rules at the new SCP-AN or REF 752.

In step 704, the NRF 751 may send a WTRU configuration notification to the new SCP-AN or REF 752. The request includes a WTRU identifier and the RAN node identifier, and may include NF-identifiers and dispatch rules that may be associated with the WTRU or AN.

In step 705a, the new SCP-AN or REF 752 sends a WTRU configuration request to the AMF 753 to obtain WTRU specific NAS key material (e.g., NAS decryption keys and NAS count) determined by the AMF 753. The AMF 753 determines, as shown at step 705b, the WTRU specific NAS key material (e.g., NAS decryption keys and NAS count), and as shown at step 705c, sends an AN configuration request including the NAS key material to the SCP-AN or REF 752. This is similar to the procedure described with respect to step 508 of FIG. 5, described substantially herein.

In step 706, the new SCP-AN or REF 752 may store the information included in the response in a memory cache to be used when handling and dispatching messages received from the RAN node.

Those of ordinary skill in the art will appreciate that a SCP-AN/REF discovery with the NRF following the mobility procedure will result in the appropriate SCP-AN or REF to be discovered for the mobile WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method performed by a first network node, the method comprising:
receiving a first message including an identifier associated with a radio access network (RAN) node;
sending a second message to a second network node, the second message including the identifier associated with the RAN node;
receiving a third message from the second network node, the third message including non-access stratum (NAS) key information associated with one or more wireless transmit/receive units (WTRUs);
receiving a fourth message from a requesting WTRU, the fourth message including an encrypted NAS payload;
decrypting the encrypted NAS payload using security context information to obtain content of the fourth message, wherein the security context information is determined based on at least a portion of the NAS key information;
determining a destination network function endpoint based on the content of the fourth message;
generating a fifth message based on the content of the fourth message;
sending the fifth message to the determined destination network function endpoint; and
receiving a sixth message from the determined network function in response to the fifth message.

2. The method of claim 1, wherein the third message includes one or more identifiers associated respectively with the one or more WTRUs.

3. The method of claim 1, wherein sending the fifth message further comprises converting a payload of the fourth message into a message format to be used to send the fifth message.

4. The method of claim 1, wherein the fifth message and the sixth message are sent on a system bus interface (SBI).

5. The method of claim 1, wherein determining the destination network function endpoint comprises applying one or more configured dispatch rules.

6. The method of claim 1, wherein determining the destination network function endpoint comprises determining a message type or an identifier associated with the destination network function endpoint based on the content of the fourth message.

7. The method of claim 1, wherein the first message includes one or more WTRU identifiers.

8. The method of claim 1, wherein the fourth message includes a first counter value, wherein the method further comprises sending a message to the WTRU via the RAN node, wherein the message includes a second counter value.

9. The method of claim 6, wherein sending the fifth message further comprises validating whether a counter value included in the fourth message is coherent with a counter value included in the NAS key information.

10. The method of claim 1, further comprising:
sending a message including one or more of: an identifier associated with a network function, a type associated with the network function, endpoint information, or an identifier associated with a public land mobile network (PLMN); and
receiving a message including one or more of: an indication of a registration status for the network function or a registration identifier.

11. A network node comprising:
a processor configured to receive a first message including an identifier associated with a radio access network (RAN) node;
the processor configured to send a second message to a second network node, the second message including the identifier associated with the RAN node;
the processor configured to receive a third message from the second network node, the third message including non-access stratum (NAS) key information associated with one or more wireless transmit/receive units (WTRUs);
the processor configured to receive a fourth message from a requesting WTRU, the fourth message including an encrypted NAS payload;
the processor configured to decrypt the encrypted NAS payload using security context information to obtain content of the fourth message, wherein the security context information is determined based on at least a portion of the NAS key information;
the processor configured to determine a destination network function endpoint based on content of the fourth message;
the processor configured to generate a fifth message based on the content of the fourth message;
the processor configured to second the fifth message to the determined destination network function endpoint; and
the processor configured to receive a sixth message from the determined network function in response to the fifth message.

12. The network node of claim 11, wherein the third message includes one or more identifiers associated respectively with the one or more WTRUs.

13. The network node of claim 11, the processor further configured to:
convert a payload of the fourth message into a message format to be used to send the fifth message.

14. The network node of claim 11, wherein the fifth message and the sixth message are sent on a system bus interface (SBI).

15. The network node of claim 11, the processor further configured to determine the destination network function endpoint by applying one or more configured dispatch rules.

16. The network node of claim 11, the processor further configured to determine a message type or an identifier associated with the destination network function endpoint based on the content of the fourth message.

17. The network node of claim 11, wherein the first message includes one or more WTRU identifiers.

18. The network node of claim 11, wherein the fourth message includes a first counter value, wherein the method further comprises sending a message to the WTRU via the RAN node, wherein the message includes a second counter value.

19. The network node of claim 16, the processor further configured to validate whether a counter value included in the fourth message is coherent with a counter value included in the NAS key information.

20. The network node of claim 11, the processor further configured to:
send a message including one or more of: an identifier associated with a network function, a type associated with the network function, endpoint information, or an identifier associated with a public land mobile network (PLMN); and
receive a message including one or more of: an indication of a registration status for the network function or a registration identifier.
